(19) United States
(12) Patent Application Publication
(10) Pub. No.: US 2005/0024390 A1
(43) Pub. Date: Feb. 3, 2005

(54) Video signal processing circuit, display apparatus and video signal processing method

(75) Inventor: Tohru Kimura, Tokyo (JP)

Correspondence Address: Paul J. Esatto, Jr.;Scully, Scott, Murphy & Presser, 400 Garden City Plaza, Garden City, NY, 11530, US

(73) Assignee: NEC Plasma Display Corporation, Tokyo (JP)

(21) Appl. No.: 10/901,752

(22) Filed: Jul. 29, 2004

(30) Foreign Application Priority Data
Jul. 30, 2003 (JP) 2003-282268

(51) Int. Cl. G09G 3/00

(52) U.S. Cl. 345/690; 345/30

(57) ABSTRACT

Disclosed are a video signal processing circuit, a display apparatus and a video signal processing method which can restrain superimposition of noise on video signals to be saved in a frame memory or malfunction of the frame memory. The video signal processing circuit performs subfield coding on video signals to be input and outputs the video signals to a display section. The circuit has a frame memory which temporarily saves one frame of or one field of video signals before outputting the video signals to the display section and whose memory capacity depends on the product of the quantity of bits of video signals to be input and the quantity of display cells of the display section.

### BACKGROUND OF THE INVENTION

1. Field of the Invention

The present invention relates to a video signal processing circuit, a display apparatus and a video signal processing method.

2. Description of the Related Art

Display devices equipped on flat panel displays include, for example, a plasma display panel (PDP), an organic/inorganic electroluminescence (EL) panel, and a projection panel using a direct mirror device (DMD).

Because each of those display devices is a digital device each of whose display cells takes only binary values of “emission” and “non-emission”, gradations are expressed by controlling the number of light emissions of each display cell. That is, in ensuring, for example, 8-bit gradations for individual display cells of R (Red), G (Green) and B (Blue) that are used in color display, an intermediate gradation is expressed by controlling the number of light emissions of each display cell to a proper value between 0 to 255 (or common multiples of values from 0 to 255 and integers close to the common multiples). This can allow a natural image to be displayed. Hereinafter, individual display cells of R, G and B are called color cells, and a group of three display cells of R, G and B (R, G and B color cells) is called a pixel.

A display device which provides gradations by controlling the number of light emissions of each display cell generally employs a subframe scheme (subfield scheme) to divide one frame (or one field) into a plurality of subframes (or subfields) and assigning the number of light emissions to each subframe (or each subfield) at the time of displaying one frame of video images. For the sake of simplicity, the wording “frame” includes the meaning of “field” and a subframe is abbreviated hereinafter as “SF”.

One way to provide the aforementioned 8-bit gradations for each color cell, for example, is to assign the number of light emissions, 1, 2, 4, 8, 16, 32, 64 and 128, to eight SFs from SF1 or the first SF in the display order to SF8 or the last (eighth) one in the display order and control emission/non-emission of the individual SFS independently for each color cell.

In case of a display device which, like a PDP, has a relatively long display period for each SF (a display device which uses much time in one frame period as a display emission time), dividing a frame into SFs whose quantity is equal to the number of bits of input video signals for the expression of gradations as mentioned above would cause degradation of the image quality, called “dynamic false contour”.

It is typical to use a scheme called “redundancy coding” for the purpose of preventing the image quality from being degraded by occurrence of dynamic false contours.

The problem and solution are given in detail in S. Mikoshiba, “Latest Plasma Display Technology”, ED Research Co., Ltd., pp. 104 and 115, and H. Uchiike and S. Mikoshiba, “Everything About Plasma Display—Promising Large Wall-Hanging Television—”, Kogyo Chosakai Publishing Co., Ltd., pp. 163-178.

In using redundancy coding, the number of SFs, n, included in one frame has a relationship of n>log₂ N where N is the number of gradations of input video images. In other words, it has a relationship of 2ⁿ>N. In an actual PDP, the value of the SF number n in use is “11” or “12” with respect to an input of, for example, 8-bit video signals (i.e., gradation number N=256).

It is typical that one frame of video signals (video data) to be input to a display apparatus is input in order from data corresponding to the topmost scan line on the display screen to data corresponding to the bottommost scan line and data corresponding to each scan line is input in order from data corresponding to the leftmost color cell on the scan line to data corresponding to the rightmost color cell according to the conventionally most typical display system of a CRT (Cathode Ray Tube).

By way of comparison, the display apparatus that employs the SF scheme should input emission/non-emission information (gradation value information) of all the SFs in one frame (i.e., SF1 to SF11 or SF12, for example) for each pixel into a display device before the first SF in one frame in the display order (i.e., SF1) is displayed. It is therefore essential that the display apparatus that employs the SF scheme should have a frame memory which temporarily holds (buffers) one frame of video signals which have been input according to the scan order of a CRT and subjected to SF coding in the way mentioned above, before the video signals are output to the display device (see, for example, Japanese Patent Laid-Open Publication No. 2003-15594 (FIG. 3)).

Referring now to FIG. 1, a conventional video signal processing circuit 100 having a plasma display apparatus as one example of a display apparatus will be explained.

As shown in FIG. 1, the video signal processing circuit 100 comprises a first video signal processing section 101, an SF coding section 102, a first line memory (constituted by an SRAM) 103, a memory control section 104, a frame memory 105, a second video signal processing section 106 and a second line memory 107.

Those components of the video signal processing circuit 100, excluding the frame memory 105, are provided on a signal processing LSI 108. The signal processing LSI 108 is mounted, together with the frame memory 105, on a digital board 109.

The individual components function as follows.

R (Red), G (Green) and B (Blue) video signals (each of 8 bits) to be input to the signal processing LSI 108 first undergo video signal processing in the first video signal processing section 101, then undergo SF coding in the SF coding section 102.

The video signals undergone SF coding are converted by the first line memory 103 and the memory control section 104 to adequate signals to be written in the frame memory 105, and are then written in the frame memory 105 by the memory control section 104.

Writing here is carried out after the video signals are sorted in such a way that data is arranged SF by SF. This is because a change in row address takes more than a change in column address or bank address. Specifically, when a 128 Mb×32 DDR-SDRAM (K4D263238A-GC33) by Samsung, for example, is used as a frame memory and is operated at 333 MHz, the column address can be changed in 3.3 ns (nanoseconds) while the row address cannot be changed for 56.6 ns which is 17 times the former time (see, for example, “128 Mb DDR SDRAM 1M×32 bit×4 banks, Double Data Rate Synchronous RAM with Bi-Directional Data Strobe and DLL”, Rev. 1.5, Samsung Electronics, December 2001. As will be discussed later, the maximum memory bus band width is generally required at the time of reading data from the frame memory 105 in transmission and reception of video signals between the memory control section 104 and the frame memory 105. It is therefore necessary to prepare pre-sorted data and write the data in the frame memory 105 so that a changing the row address should not be needed at the time of reading data from the frame memory 105. A static random access memory (SRAM) is one conventional memory LSI which can change the row address at substantially the same speed as the column address. But, there has not been an SRAM whose memory capacity is large enough to be adaptable as a frame memory, or such an SRAM, if it exists, is very expensive.

The video signals temporarily saved in the frame memory 105 are read out by the memory control section 104 SF by SF and output to the second video signal processing section 106. The second video signal processing section 106 performs necessary signal processing on the video signals after SF coding and sends the resultant signals to the second line memory 107. The video signals are so arranged as to be video signals for each scan line on the plasma display panel by the second line memory 107, and are then output to a high voltage board (not shown).

The capacity (memory capacity) of the frame memory 105 equipped in the conventional video signal processing circuit 100 can be given by the following equation 1 in the case of W-XGA display of, for example, 1365 pixels per scan line and 768 lines per frame.

Memory capacity:
1365×768×3×n×2=about 6×n(Mb) (1)

Of the individual values to be multiplied in the equation 1, “1365” is the number of pixels per scan line, “768” is the number of scan line per frame, “3” is a value corresponding to the number of color cells (three cells of R, G and B) included in one pixel, “n” is a value corresponding to the number of SFs in one frame, and “2” is a value given in consideration of double buffering that is needed to simultaneously perform writing and reading of one frame of data.

While the SF division number n in the PDP is, for example, 11 or 12 as mentioned above, the frame memory capacity required in this case is 66 Mb (when n=11) or 72 Mb (when n=12) as derived from the equation 1.

What is more, smooth execution of the display operation requires the memory band width that achieves the data transfer at a transfer rate at which data whose quantity is defined by the equation 1 can be input to (written in) and output to (read from) the frame memory within one frame period.

For 60-Hz display, for example, the “one frame period” is 1/60= about 16.67 ms (milliseconds). For a display device like a PDP, the priming period, scan period (display data writing period) and emission sustaining period for displaying video images are needed in one frame period, so that the period which can be used in writing and reading video data in and from the frame memory is a part of the display period for one frame. Further, the times needed to read and write one frame of video data with respect to the frame memory are closely associated with the scan period, and actually the maximum memory bus band width is defined by the scan period (= the time to write pixel data for one horizontal line into the display device). That is, generally, the scan period determines the speed of reading data from the frame memory and the maximum memory bus band width is needed at the time of reading data from the frame memory 105 in transmission and reception of video signals between the memory control section 104 and the frame memory 105. For the existing PDPs, it is apparent from the luminous electric characteristics of color cells that the scan period for one line is about 1 μs (microseconds) to 2 μs. Given that the scan period is 1 μs, for example, therefore, the maximum memory bus band width that is needed in W-XGA display is defined by the following equation 2.

Maximum memory bus band width:
1365×3×2/1(μs)=about 8.2 Gb/s (2)

The individual values “1365”, “3” and “2” to be multiplied in the equation 2, as in the equation 1, are respectively the number of pixels per scan line, the number of color cells, and a value given with double buffering taken into consideration.

In case of the dual scan system which writes two lines of data in the display device at a time, the maximum memory bus band width required is twice the value defined by the equation 2.

In case where the frame memory (which is also called frame buffer) is constructed by a memory LSI, it is typical to use a dynamic random access memory (DRAM) to secure the capacity defined by the equation 1.

When W-XGA display is carried out with the SF division number being 12 and the scan period being 1 μs, the frame memory that satisfies the conditions given in the equations 1 and 2 can be constructed by operating a DRAM with 128 Mb and 32 IO (also displayed as “x32”) at 256 MHz in case of a synchronous DRAM which is a mainstream memory at present or by operating a DRAM with 128 Mb and 32 IO at 128 MHz in case of a double data rate synchronous DRAM.

The interface (IF) voltage of the DRAM that constitutes the frame memory becomes 2.5 V or lower, thus requiring that video signals should be written in and read from the frame memory at the logical amplitude of such a low voltage.

By way of contrast, a PDP, EL or DMD has a high voltage circuit system which uses a high voltage of several tens to several hundred voltages for data display. The flow rate of the current in the high voltage circuit system tends to increase (to, for example, several amperes or so) with an increase in the size of the display screen. Accordingly, the high voltage circuit system would suffer very large power supply/GND noise generated with respect to the logical amplitude of video signals to be written in and read from the frame memory.

In other words, according to the prior art, noise is superimposed on video signals to be held in the frame memory due to noise generated in the high voltage circuit system, thereby producing noise also on a video image to be displayed based on the video signals or causing malfunction of the frame memory.

### SUMMARY OF THE INVENTION

Accordingly, it is an object of the invention to provide a video signal processing circuit, a display apparatus and a video signal processing method which can suppress superimposition of noise on video signals to be saved in a frame memory or malfunction of the frame memory.

To achieve the object, according to the invention, there is provided a video signal processing circuit which performs subfield coding on video signals to be input and outputs those video signals to a display section. The video signal processing circuit comprises a frame memory which temporarily saves one frame of or one field of video signals before the video signals are output to the display section and whose memory capacity depends on a product of a number of bits of video signals to be input and a number of display cells of the display section.

Video signals in one frame or one field which are held in the frame memory of the video signal processing circuit according to the invention are more specifically still or dynamic video signals, i.e., video signals whose data capacity depends on the product of the number of bits and the number of display cells. Therefore, video signals added with, for example, a Z buffer (screen's depth information) and alpha blend value (information which expresses transmissivity) as used in a 3D (Three-Dimensional) video image are not included in the video signals that are saved in the frame memory of the video signal processing circuit according to the invention.

The “number of display cells of the display section” means the total number of the RGB or YCbCr/YPbPr display cells of the display section.

In the video signal processing circuit according to the invention, it is preferable that saving of one frame of or one field of video signals should be executed prior to the subfield coding, followed by execution of the subfield coding on those video signals which are read out from the frame memory.

A video signal processing circuit according to the invention performs subfield coding on video signals to be input and outputs those video signals to a display section, and comprises a frame memory which temporarily saves one frame of or one field of video signals prior to the subfield coding, after which the subfield coding is performed on those video signals which are read out from the frame memory.

In the video signal processing circuit according to the invention, it is preferable that the subfield coding should be carried out in such a way as to satisfy a relationship of n>log₂ N where n is a number of divided subfields in one frame of or one field of video signals and N is a number of gradations of the video signals to be input.

In the video signal processing circuit according to the invention, it is preferable that the subfield coding should be performed by a look-up table system using a memory circuit.

In the video signal processing circuit according to the invention, it is preferable that the subfield coding should be performed by using an arithmetic logic operation.

In the video signal processing circuit according to the invention, it is preferable that the frame memory should be a random accessible memory.

A display apparatus according to the invention has the video signal processing circuit of the invention and a display section that displays video images based on video signals undergone subfield coding which are output from the video signal processing circuit.

A preferable example of the display apparatus according to the invention is a plasma display panel as the display section.

A video signal processing method according to the invention performs subfield coding on video signals to be input and outputs those video signals to a display section, and comprises a first step of temporarily saving one frame of or one field of video signals in a frame memory prior to the subfield coding; and a second step of performing the subfield coding on those video signals which are read out from the frame memory.

It is preferable that at the second step, the subfield coding should be carried out in such a way as to satisfy a relationship of n>log₂ N where n is a number of divided subfields in one frame of or one field of video signals and N is a number of gradations of the video signals to be input.

As a preferable example of the video signal processing method, at the second step, the subfield coding is performed by a look-up table system using a memory circuit.

It is also preferable that at the second step, the subfield coding should be performed by using an arithmetic logic operation.

The inventor find out that the problems of the prior art are brought about due to the following reasons.

To display a W-XGA video image on a PDP with a frame memory constituted by a memory LSI in the aforementioned manner, data transfer of video signals to be written in and read from the frame memory should be performed at a high speed of, for example, 100 MHz,or higher.

What is more, video signal after SF coding, i.e., video signals with a larger amount of data than input video signals because of redundancy coding are saved in the frame memory according to the prior art. That is, a vast amount of data is transferred at a high speed, so that noise is likely to be mixed into the video signals, thereby degrading the quality of video images.

Contrast to this, the present invention can reduce the memory capacity of the frame memory and the average data transfer rate as compared with the prior art, because the video signal processing circuit of the present invention has a frame memory whose memory capacity depends on the product of the number of bits of video signals to be input and the number of display cells of the display section, i.e., because, unlike in the prior art, the memory capacity of the frame memory does not depend on the number of divided subfields (> the number of bits of input video signals).

More specifically, one frame of or one field of video signals is save in the frame memory prior to subfield coding, followed by execution of the subfield coding on those video signals which are read out from the frame memory. In other words, unlike in the prior art, video signals after subfield coding (which has a larger in amount than video signals before subfield coding) are not saved in the frame memory. This can reduce the memory capacity of the frame memory and the average data transfer rate lower as compared with the prior art.

This can suppress noise-originated loss of video signals or occurrence of abnormality during writing or reading video signals in or from the frame memory.

In addition, the data transfer rate of the frame memory can be reduced, thus making it possible to decrease the required memory bus band width.

### BRIEF DESCRIPTION OF THE DRAWINGS

FIG. 1 is a block diagram showing a video signal processing circuit equipped on a conventional plasma display apparatus; and

FIG. 2 is a block diagram showing a video signal processing circuit as a preferable example of a display apparatus according to the invention.

### DETAILED DESCRIPTION OF THE PREFERRED EMBODIMENT

One embodiment of the present invention will be described below with reference to the accompanying drawings. The description of the embodiment will discuss a plasma display apparatus as an adequate example of a display apparatus according to the invention, a video signal processing circuit equipped on the plasma display apparatus and a video signal processing method employed in the display apparatus and the video signal processing circuit.

To begin with the structure of the embodiment will be discussed.

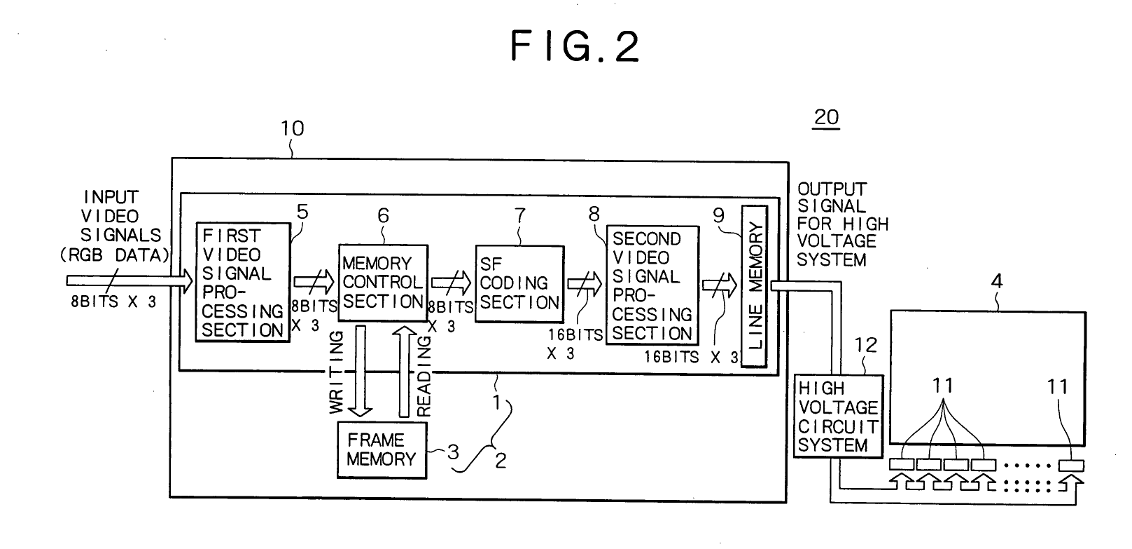

As shown in FIG. 2, a plasma display apparatus 20 according to the embodiment has a signal processing LSI 1 which performs various kinds of signal processing on input video signals of a predetermined number of bits (e.g., 8 bits in the embodiment; therefore, the number of input gradations=256), a frame memory 3 which, together with the signal processing LSI 1, constitutes a video signal processing circuit 2, and a plasma display panel 4 (hereinafter “PDP 4”) serving as a display section which displays video images based on video signals output from the video signal processing circuit 2.

The signal processing LSI 1 includes a first video signal processing section 5, a memory control section 6, an SF coding section 7, a second video signal processing section 8 and a line memory 9 and is provided, together with the frame memory 3, on a digital board 10.

Of the components, the first video signal processing section 5 performs video signal processing on R (Red), G (Green) and B (Blue) video signals (each of 8 bits) to be input to the signal processing LSI 1, then outputs the resultant signals to the memory control section 6.

The frame memory 3 is constituted by, for example, a DRAM (Dynamic Random Access Memory) and temporarily saves one frame of or one field of video signals to be written by the memory control section 6 before the video signals are output to the PDP 4. More specifically, the frame memory 3 temporarily saves one frame of or one field of video signals of one screen of still pictures or dynamic pictures on the PDP 4. In case where the frame memory 3 is constituted by a DRAM, the memory control section 6 is constituted by a DRAM controller.

The SF coding section 7 performs SF coding on video signals from the memory control section 6 and outputs the resultant signals to the second video signal processing section 8.

The second video signal processing section 8 performs video signal processing on the video signals from the SF coding section 7 and outputs the resultant signals to the line memory 9.

The line memory 9 outputs the video signals from the second video signal processing section 8 to the PDP 4 (more specifically, to a high voltage circuit system 12).

The PDP 4 displays video images based on video signals input from the high voltage circuit system 12 (via an IC driver 11). That is, the PDP 4 displays video images based on video signals undergone subfield coding which are output from the signal processing LSI 1.

The operation of the embodiment will be discussed below.

First, R (Red), G (Green) and B (Blue) video signals (RGB signals) to be externally input to the signal processing LSI 1 on the digital board 10 are sent to the memory control section 6 after they are subjected to video signal processing in the first video signal processing section 5.

Next, the memory control section 6 converts the video signals from the first video signal processing section 5 to adequate signals to be written in the frame memory 3 constituted by the DRAM, and performs a process to write the video signals into the frame memory 3.

The frame memory 3 temporarily saves one frame of or one field of video signals to be written by the memory control section 6.

Next, the memory control section reads the video signals from the frame memory 3 and outputs the video signals to the SF coding section 7.

Then, the SF coding section 7 performs SF coding on the video signals.

As the frame memory 3 in the embodiment saves video signals which have not undergone SF coding, it is necessary to perform SF coding on video signals, after they are read from the frame memory 3, before the video signals are output to the high voltage circuit system 12. It is to be noted that SF coding may be executed by a look-up table system using a memory circuit or may be performed by a logic coding system using an arithmetic logic operation.

The SF coding section 7 outputs video signals undergone SF coding to the second video signal processing section 8. The second video signal processing section 8 subjects the video signals to video signal processing that is needed after SF coding, then outputs the resultant signals to the line memory 9. In the line memory 9, the video signals are arranged to be signals for each scan line on the PDP 4 and are then output to the high voltage circuit system 12 on the high voltage board (not shown). Further, the video signals are input to the PDP 4 from the high voltage circuit system 12 via the IC driver 11 and the PDP 4 displays a video image based on the video signals.

In the signal processing, the video signals up to the stage at which the video signals are read from the frame memory 3 by the memory control section 6 are of the RGB signal form to be input to the signal processing LSI 1. Therefore, the required memory capacity of the frame memory 3 in the embodiment is defined by the following equation 3 which is given on the premise that W-XGA display is taken and each video signal to be input consists of 8 bits, as mentioned in the BACKGROUND OF THE INVENTION.

Memory capacity:
1365×768×3×8×2×about 48 (Mb) (3)

Of the individual values to be multiplied in the equation 3, “1365”, “768”, “3” and “2” are respectively the number of pixels per scan line, the number of scan line per frame, the number of color cells included in one pixel, and a value given with double buffering taken into consideration, and “8” is the number of bits of input video signals.

As apparent from the above, the memory capacity of the frame memory, which should be as large as 66 Mb or 72 Mb according to the prior art, can be reduced to approximately 48 Mb in the embodiment. That is, the required memory capacity has only to be ⅔ to 8/11 of the memory capacity needed conventionally.

In the equation 3, 1365 (the number of pixels per scan line)×365 (the number of scan line per frame)×3 (the number of display cells included in one pixel) is the number of display cells per frame. That is, let the number of display cells per frame be s, the equation 3 can be expressed by a simplified equation 4 given below.

Memory capacity:
s×8×2 (4)

The memory capacity of the frame memory 3 in the embodiment is a value which depends on the product of “s” or the number of display cells of the display screen of the PDP 4 and “8” or the number of bits of input video signals and is determined by the display cell number s and the bit quantity of “8”.

By way of comparison, the equation 1 associated with the prior art, if simplified by letting the number of display cells per frame be s, becomes the following equation 5.

Memory capacity:
s×n×2 (5)

The memory capacity of the frame memory 105 in the prior art is a value which is determined by the display cell number s and the SF division number n (specifically, n=11 or 12, for example), and is greater than the memory capacity in the embodiment.

In the embodiment, the maximum memory bus band width that is needed in transmission and reception of video signals between the frame memory 3 and the memory control section 6 is defined by the following equation 6 where the scan period needed to write one line of video data in the PDP 4 is 1 μs.

Maximum memory bus band width:
1365×3×2/1(μs)=about 8.2 Gb/s (6)

The individual values “1365”, “3” and “2” to be multiplied in the equation 6, as in the equation 2, are respectively the number of pixels per scan line, the number of color cells, and a value given with double buffering taken into consideration.

As apparent from the equation 6, the maximum memory bus band width needed to display data is the same value as that in the prior art (in the case of the equation 2), so that the maximum speed of reading video signals from the frame memory 3 becomes the same as that of the prior art. In case of NTSC signals (60 Hz), for example, the average memory bus band width needed to display one screen becomes as follows as apparent from the equations 3 and 1.

In the case of the embodiment,
48 (Mb)×60 (Hz)=2.88 Gb/s

In the case of the prior art,
72 (Mb)×60 (Hz)=4.32 Gb/s (SF division number=12)
or
66 (Mb)×60 (Hz)=3.96 Gb/s (SF division number=11)

It is apparent that, like the memory capacity, the required memory capacity in the embodiment has only to be ⅔ to 8/11 of the memory capacity needed in the prior art.

The embodiment can execute data writing to and reading from the frame memory 3 without sorting video signals that is needed in the prior art for the following reason.

Recently, a DRAM which can access the row addresses at about the same speed as the column addresses has appeared as disclosed in “64-Mb 6.8 ns Random Row Access DRAM Macro for ASICs”, by Kimura (present inventor) et al., 1999, IEEE International Solid State Circuits Conference Digest of Technical Papers, Vol. 42, p 416, WP 24.4. The use of such a DRAM eliminates the need for writing video data sorted due to a slow change in row address (the sorting process in the prior art).

Because the video signal processing circuit according to the embodiment has a frame memory whose memory capacity depends on the product of the number of bits of video signals to be input and the number of display cells s of the PDP 4, i.e., because, unlike in the prior art, the memory capacity of the frame memory 3 does not depend on the number of divided subfields (> the number of bits of input video signals), the embodiment can reduce the memory capacity of the frame memory 3 and the average data transfer rate as compared with the prior art.

More specifically, one frame of or one field of video signals is save in the frame memory 3 prior to subfield coding, followed by execution of the subfield coding on those video signals which are read out from the frame memory 3. In other words, unlike in the prior art, video signals after subfield coding (which has a larger in amount than video signals before subfield coding) are not saved in the frame memory 3. This can reduce the memory capacity of the frame memory 3 and the average data transfer rate lower as compared with the prior art.

This can suppress noise-originated loss of video signals or occurrence of abnormality during writing or reading video signals in or from the frame memory 3.

In addition, the data transfer rate of the frame memory 3 can be reduced, thus making it possible to decrease the required memory bus band width.

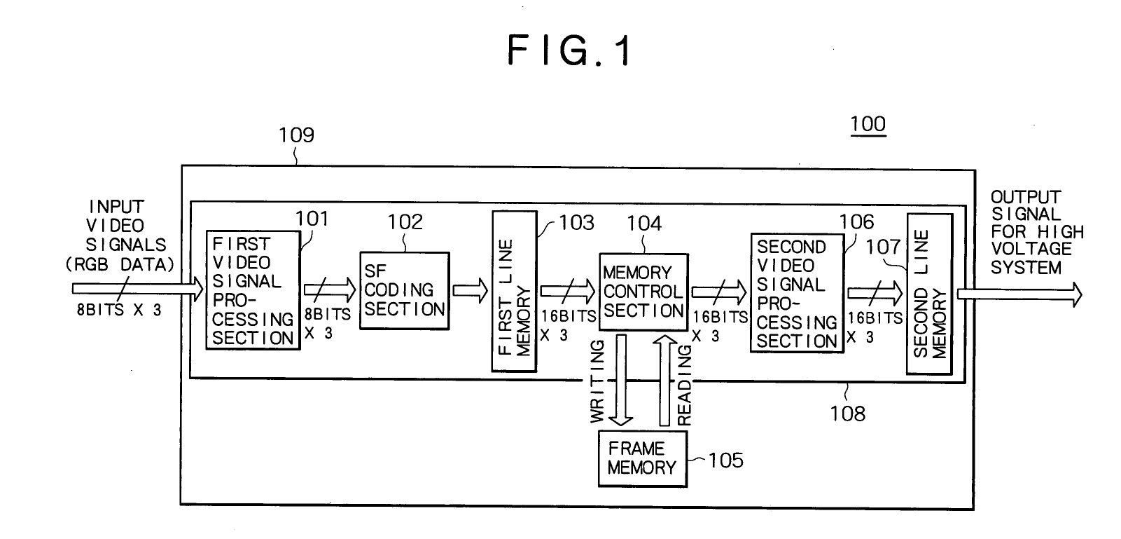

The prior art requires two lines memories 103 and 107 as shown in FIG. 1, for example, whereas the embodiment can reduce the number of line memories to one (line memory 9) as shown in FIG. 2.

Although the foregoing description of the embodiment has been given of a plasma display apparatus equipped with a PDP as one example of the display apparatus according to the invention, the invention is not limited to this particular type, but may be adaptable to a display apparatus equipped with, for example, an EL panel or a projection panel using a DMD.

1. A video signal processing circuit that performs subfield coding on video signals to be input and outputs those video signals to a display section, said video signal processing circuit comprising:
a frame memory which temporarily saves one frame of or one field of video signals before said video signals are output to said display section and whose memory capacity depends on a product of a number of bits of video signals to be input and a number of display cells of said display section.

2. The video signal processing circuit according to claim 1, wherein saving of one frame of or one field of video signals is executed prior to said subfield coding, then said subfield coding is performed on those video signals which are read out from said frame memory.

3. A video signal processing circuit that performs subfield coding on video signals to be input and outputs those video signals to a display section, said video signal processing circuit comprising:
a frame memory which temporarily saves one frame of or one field of video signals prior to said subfield coding, after which said subfield coding is performed on those video signals which are read out from said frame memory.

4. The video signal processing circuit according to claim 1, wherein said subfield coding is carried out in such a way as to satisfy a relationship of n>log₂ N where n is a number of divided subfields in one frame of or one field of video signals and N is a number of gradations of said video signals to be input.

5. The video signal processing circuit according to claim 3, wherein said subfield coding is carried out in such a way as to satisfy a relationship of n>log₂ N where n is a number of divided subfields in one frame of or one field of video signals and N is a number of gradations of said video signals to be input.

6. The video signal processing circuit according to claim 1, wherein said subfield coding is performed by a look-up table system using a memory circuit.

7. The video signal processing circuit according to claim 3, wherein said subfield coding is performed by a look-up table system using a memory circuit.

8. The video signal processing circuit according to claim 1, wherein said subfield coding is performed by using an arithmetic logic operation.

9. The video signal processing circuit according to claim 3, wherein said subfield coding is performed by using an arithmetic logic operation.

10. The video signal processing circuit according to claim 1, wherein said frame memory is a random accessible memory.

11. The video signal processing circuit according to claim 3, wherein said frame memory is a random accessible memory.

12. A display apparatus having a video signal processing circuit as recited in claim 1 and a display section.

13. A display apparatus having a video signal processing circuit as recited in claim 3 and a display section.

14. The display apparatus according to claim 12, wherein said display section is a plasma display panel.

15. The display apparatus according to claim 13, wherein said display section is a plasma display panel.

16. A video signal processing method that performs subfield coding on video signals to be input and outputs those video signals to a display section, and comprises:
a first step of temporarily saving one frame of or one field of video signals in a frame memory prior to said subfield coding; and
a second step of performing said subfield coding on those video signals which are read out from said frame memory.

17. The video signal processing method according to claim 16, wherein at said second step, said subfield coding is carried out in such a way as to satisfy a relationship of n>log₂ N where n is a number of divided subfields in one frame of or one field of video signals and N is a number of gradations of said video signals to be input.

18. The video signal processing method according to claim 16, wherein at said second step, said subfield coding is performed by a look-up table system using a memory circuit.

19. The video signal processing method according to claim 16, wherein at said second step, said subfield coding is performed by using an arithmetic logic operation.
